(19) United States
(12) Patent Application Publication
(10) Pub. No.: US 2019/0193614 A1
(43) Pub. Date: Jun. 27, 2019

(54) VEHICLE SEAT

(71) Applicant: TOYOTA BOSHOKU KABUSHIKI KAISHA, Aichi (JP)

(72) Inventors: Tomohiro NAKAO, Aichi-ken (JP); Takeshi SHIMOSATO, Aichi-ken (JP)

(73) Assignee: TOYOTA BOSHOKU KABUSHIKI KAISHA, Aichi (JP)

(21) Appl. No.: 16/313,114

(22) PCT Filed: Jun. 29, 2017
(86) PCT No.: PCT/JP2017/023996

§ 371 Date: Dec. 24, 2018

(30) Foreign Application Priority Data
Jun. 29, 2016 (JP) 2016-128643

(51) Int. Cl. B60N 2/70; B60N 2/68

(52) U.S. Cl. CPC B60N 2/7094; B60N 2/68

(57) ABSTRACT

The vehicle seat includes a cushion material in which a soft pad and a hard pad having different hardness from each other are combined. The soft pad is provided with an engagement protrusion protruding toward the hard pad, and the hard pad is provided with a recessed portion receiving the engagement protrusion. The recessed portion has a wall surface extending in a direction intersecting an assembling direction of the soft pad and the hard pad. One of the wall surface and the engagement protrusion includes a protruding portion, and another of the wall surface and the engagement protrusion includes an engagement portion which engages with the protruding portion. The protruding portion and the engagement portion are engaged with each other to restrict relative movement between the soft pad and the hard pad in the assembling direction.

### TECHNICAL FIELD

The present invention relates to a vehicle seat mounted on a vehicle such as an automobile, an airplane, a ship, a train, etc.

### BACKGROUND ART

As an example of a vehicle seat, a seat using a cushion material which combines a soft pad and a lightweight hard pad provided on a back surface side of the soft pad for weight reduction, etc., is exemplified. As a method of integrating the pads, a method of bonding the pads and a method of mechanically coupling the pads are exemplified. In Patent Document 1, the latter method (mechanical coupling) has been studied from the viewpoint that the former method (bonding) causes hardening of the interface between the pads and adversely affecting sitting comfort.

Specifically, in Patent Document 1, a wire which is used for mechanical coupling is integrated with the soft pad, and the wire is penetrated through the hard pad and coupled to a vehicle body structural member (hereinafter referred to as a “seat fixed member”).

### PRIOR ART DOCUMENT

### Patent Document

Patent Document 1: Japanese Patent No. 5520582

### SUMMARY OF THE INVENTION

### Problems to be Solved by the Invention

In the method described in Patent Document 1, the pads are integrated by coupling a wire to a vehicle body structural member (in other words, assembling a seat to the vehicle body). That is, a soft pad and a hard pad are not integrated until the seat is assembled to the vehicle body. Therefore, in fact, when assembling the seat to the vehicle body, mutual positions of the pads are adjusted so as to prevent displacement between the soft pad and the hard pad. Such adjustment of the mutual positions may be a reason why workability of the work of assembling the seat to the vehicle is lowered.

It is an object of the present invention to provide a vehicle seat in which a soft pad and a hard pad configuring a cushion material of the vehicle seat are mechanically integrated with each other and which can be assembled to a vehicle without requiring adjustment of mutual positions of the soft pad and the hard pad configuring.

### Means for Solving the Problems

According to a first aspect of the present invention, a vehicle seat includes a cushion material in which a soft pad and a hard pad having different hardness from each other are combined, wherein the soft pad is provided with an engagement protrusion protruding toward the hard pad, wherein the hard pad is provided with a recessed portion receiving the engagement protrusion, wherein the recessed portion has a wall surface extending in a direction intersecting an assembling direction of the soft pad and the hard pad, wherein one of the wall surface and the engagement protrusion includes a protruding portion, wherein another of the wall surface and the engagement protrusion includes an engagement portion which is engaged with the protruding portion, and wherein the protruding portion and the engagement portion are engaged with each other to restrict relative movement between the soft pad and the hard pad in the assembling direction.

In the first aspect of the present invention, the engagement protrusion may be configured by, for example, a wire, a metal protruding piece which is fixed to a frame member of the seat, and a resin rod which is embedded and fixed in the soft pad, etc. The recessed portion may be configured by, for example, a cavity which is formed in the hard pad and a container which is fixed to the hard pad, etc. The protruding portion may be provided, for example, on the wall surface of the recessed portion and outside the engagement protrusion. The engagement portion may be configured by, for example, a wire forming the engagement protrusion, and a step portion and a recess of a wall surface of the recessed portion.

According to the first aspect of the present invention, in a state where the soft pad and the hard pad are combined, the engagement protrusion provided on the soft pad is fitted into the recessed portion provided in the hard pad. Therefore, even if one of the soft pad and the hard pad attempts to move relative to the other in a direction intersecting the assembling direction of the pads, the engagement protrusion come into contact with the wall surface of the recessed portion and the relative movement thereof is restricted. Further, even if one of the soft pad and the hard pad attempts to moves relative to the other in a direction opposite to the assembling direction (the direction in which both pads are separated), the protruding portion and the engagement portion are engaged with each other to restrict relative movement.

Therefore, the vehicle seat, in which the soft pad and the hard pad configuring the cushion material of the vehicle seat are mechanically integrated with each other, can be assembled to the vehicle without requiring adjustment of mutual positions of the soft pad and the hard pad.

According to a second aspect of the present invention, in the first aspect described above, the soft pad is fixed to the frame member serving as a framework for ensuring rigidity as the vehicle seat, and the engagement protrusion is provided to the frame member.

In the second aspect of the present invention, the frame member may be configured by, for example, a wire frame, a frame in which metal plates are combined, and an integral molding frame of a resin, etc. Further, the frame member may be embedded in the soft pad, or may be bonded to the soft pad for example.

According to the second aspect of the present invention, since the engagement protrusion is provided to the framework (frame member) of the soft pad, the coupling strength between the soft pad and the hard pad via the engagement protrusion can be enhanced as compared with a case where the engagement protrusion is provided as a separate member independent of the frame member.

According to a third aspect of the present invention, in the second aspect described above, the frame member is formed of a wire in which a wire material is molded into a predetermined shape, and the engagement protrusion is configured by the wire.

According to the third aspect of the present invention, since the engagement protrusion is configured by the wire configuring the frame member, the configuration of the engagement protrusion can be simplified as compared with the case where the engagement protrusion is provided as a separate member independent of the wire.

According to a fourth aspect of the present invention, in the third aspect described above, the engagement protrusion includes a protruding shape portion having a convex shape in which a part of the wire protrudes toward the hard pad, and the protruding shape portion is received in the recessed portion, configures the engagement portion, and is engaged with the protruding portion provided on the wall surface.

According to the fourth aspect of the present invention, since the engagement protrusion is formed on the wire forming the frame member, it is possible to eliminate the work of fixing the engagement protrusion to the frame member. Further, since the engagement portion which is engaged with the protruding portion provided on the wall surface can be configured by the protruding shape portion, it is not necessary to prepare the engagement portion as a separate member independent of the wire. Therefore, the productivity of the vehicle seat is enhanced.

According to a fifth aspect of the present invention, in the fourth aspect described above, the protruding shape portion is configured such that a width of a protruding end side portion corresponding to a protruding end of the convex shape is smaller than an interval between a pair of base end side portions corresponding to a base end of the convex shape, and the recessed portion has a recessed portion shape which corresponds to the convex shape, a width of a portion of the recessed shape portion where a pair of the protruding end side portions are arranged being smaller than a width of a portion of the recessed shape portion where the base end side portion is arranged.

According to the fifth aspect of the present invention, the shape of the recessed portion formed in the hard pad corresponds to a bent shape of the wire in which the protruding end side portion is narrower than the interval between the base end side portions. Therefore, a molding die for molding the recessed portions of the hard pad has a shape gradually expanding in the direction of separating the molding die. Therefore, as compared with the case of providing an undercut portion, etc., in the molding die, the hard pad can be easily separated from the molding die, and the hard pad can be easily manufactured.

According to a sixth aspect of the present invention, in the fifth aspect described above, the protruding shape portion includes a pair of connecting portions which connect the protruding end side portion and the pair of base end side portions, wherein a bending angle between the wire configuring one of the pair of connecting portions and the wire extending from one of the pair of base end side portions is larger than a bending angle between the wire configuring another of the pair of connecting portions and the wire extending from another of the pair of base end side portions, and wherein the one of the pair of connecting portions is arranged at a position where a larger seating pressure is received as compared with the other of the pair of connecting portions when an occupant sits on the vehicle seat.

According to the sixth aspect of the present invention, the connecting portion on the side where the bending angle is large among the pair of connecting portions which connect the protruding end side portion of the wire forming the protruding shape portion and the base end side portion is arranged at a position receiving a large seating pressure when the occupant sits on the vehicle seat. As a result, it is difficult for the connecting portion to bring a feeling of foreign matter to the occupant.

According to a seventh aspect of the present invention, in the first to sixth aspects described above, the recessed portion includes a pair of the wall surfaces, and, among the pair of wall surfaces, the protruding portion is provided on the wall surface which is provided at a position closer to a center of gravity of the hard pad.

According to the seventh aspect of the present invention, since the protruding portion is formed on the wall surface of the recessed portion of the hard pad, the undercut portion corresponding to the protruding portion is provided in the molding die of the hard pad. When the hard pad is separated from the molding die after molding, the protruding portion is separated from the molding die while being pressed against the undercut portion of the molding die and deformed. Since the protruding portion is provided on the wall surface located on a side closer to the center of gravity of the hard pad, only the protruding portion and the periphery thereof are deformed when the protruding portion is pressed against the molding die, and deformation of most of hard foam can be suppressed. Here, if the protruding portion is provided on the wall surface located on a side away from the center of gravity of the hard pad, when the hard pad is separated from the molding die, not only the protruding portion but also the hard pad located away from the center of gravity than the recessed portion (a portion from the recessed portion to an end portion of the hard pad. Generally, a wall thickness is thinner than the hard pad on the side closer to the center of gravity) may be pressed against the molding die and deformed.

According to an eighth aspect of the present invention, in the fourth aspect described above, the wire includes a plurality of the protruding shape portions, and the plurality of protruding shape portions are arranged such that a virtual plane to which the wire configuring one of the plurality of protruding shape portions belongs and a virtual plane to which the wire configuring the other of the plurality of protruding shape portions belongs intersect with each other.

According to the eighth aspect of the present invention, a plurality of protruding shape portions are provided, and a virtual plane to which a bent wire configuring one of the plurality of protruding shape portions belongs and a virtual plane to which a bent wire configuring the other of the plurality of protruding shape portions belongs intersect with each other. Therefore, when an external force is applied to the cushion material, the plurality of protruding shape portions can be prevented from being separated from the connecting portions at the same time, and engaging force between the soft pad and the hard pad as a whole of the cushion material can be enhanced.

### BRIEF DESCRIPTION OF DRAWINGS

FIG. 1 is a perspective view of a cushion pad according to one embodiment of the present invention.

FIG. 2 is a back surface side perspective view of a soft pad in the above cushion pad.

FIG. 3 is a back surface side perspective view of a hard pad in the above cushion pad.

FIG. 4 is a partially enlarged perspective view of a surface side of the above hard pad.

FIG. 5 is a partially enlarged perspective view of the surface side of the above hard pad, and is a further enlarged perspective view of a part of FIG. 4.

FIG. 6 is a partially enlarged perspective view of the surface side of the above hard pad, and is an enlarged perspective view of the other part of FIG. 5.

FIG. 7 is an enlarged cross-sectional view when viewed along a direction of arrow VII-VII in FIG. 1.

FIG. 8 is an enlarged cross-sectional view when viewed along a direction of arrow VIII-VIII in FIG. 1.

FIG. 9 is an enlarged cross-sectional view when viewed along a direction of arrow IX-IX in FIG. 1.

FIG. 10 is an enlarged cross-sectional view when viewed along a direction of arrow X-X of FIG. 1.

### MODE FOR CARRYING OUT THE INVENTION

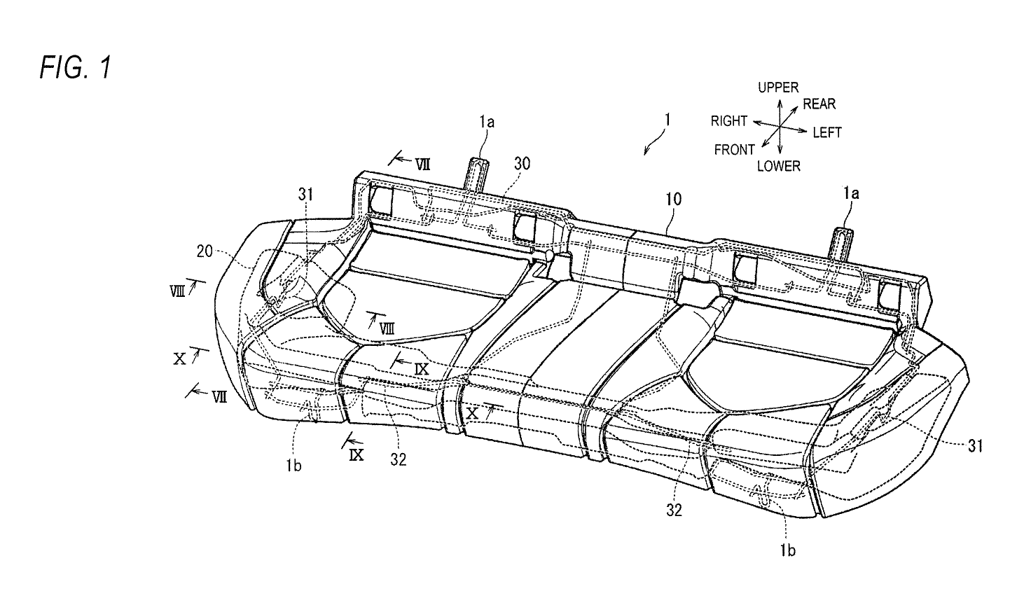

FIGS. 1 to 10 illustrate one embodiment of the present invention. This embodiment is an example in which the present invention is applied to an automobile rear seat (hereinafter simply referred to as “seat”). As well known, a seat includes a seat cushion corresponding to a seat portion and a seat back corresponding to a backrest. In this embodiment, the present invention is applied to a cushion pad 1 in the seat cushion. Arrows shown in each drawing indicate respective directions in a state where a seat is mounted on an automobile. Description on direction is made on the basis of these directions in the following description.

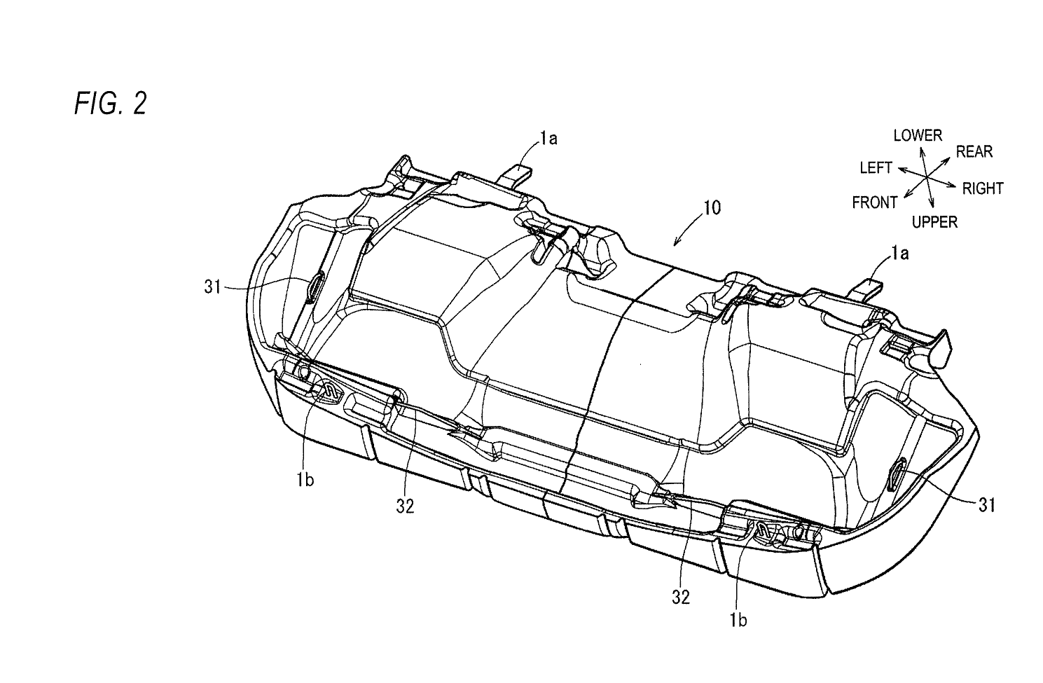

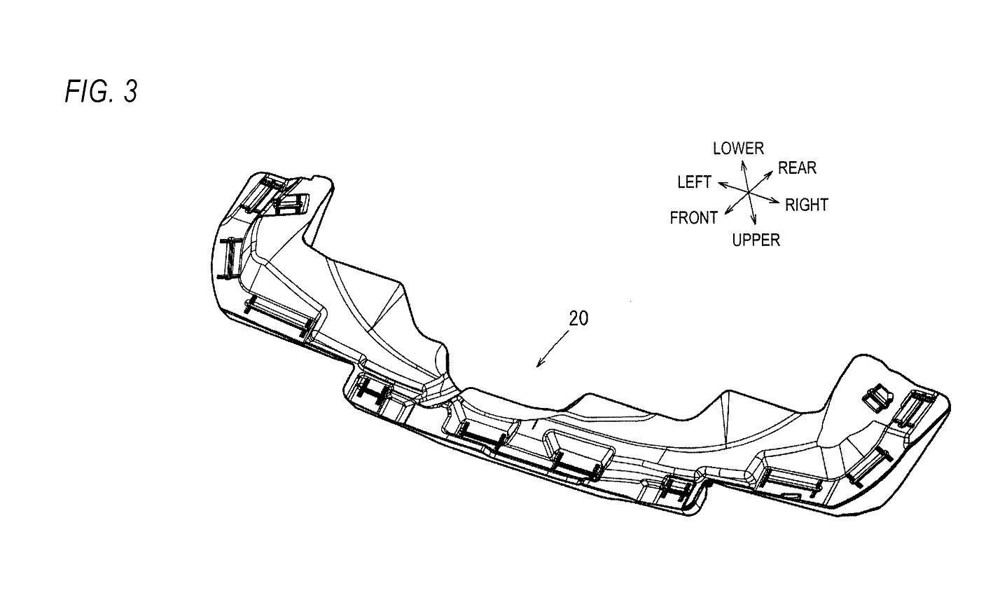

As shown in FIG. 1, the cushion pad 1 includes a cushion material in which a urethane pad (corresponding to a soft pad in the present invention) 10 and a hard foam (corresponding to a hard pad in the present invention) 20 are combined. The hardness of the urethane pad 10 and the hard foam 20 are different from each other. The urethane pad 10 is a polyurethane foam, and is formed to have an outer shape of the cushion pad 1 as shown in FIG. 2. The hard foam 20 is, for example, a polystyrene or polypropylene foam (foamed styrene), and is molded to have a shape shown in FIG. 3. The urethane pad 10 and the hard foam 20 are separately formed. The hard foam 20 may be formed by a method other than foam molding (for example, injection molding, etc.). The hard foam 20 is fixed to a back surface side of the urethane pad 10 and integrated with the urethane pad 10. The cushion material, in which the urethane pad 10 and the hard foam 20 are combined, is configured to be a main component of the cushion pad 1.

In the present embodiment, a seat surface facing an occupant when the occupant sits on a seat according to the present embodiment is referred to as a “front surface”, and a seat surface on the side opposite to the “front surface” is referred to as a “back surface”.

The urethane pad 10 has a hardness which brings an appropriate cushion feeling to the occupant seated on the seat. The hard foam 20 has a hardness superior to that of the urethane pad 10 in resistance to pressing deformation. Specifically, the hard foam 20 has a hardness enough to suppress the cushion pad 1 from being excessively deformed (excessively sunk) when the occupant sits on the cushion pad 1 after the cushion pad 1 is fixed to a vehicle body of the automobile. In addition to having such hardness, the hard foam 20 is configured by using a material which has a smaller weight per unit volume than that of the urethane pad 10. As a result, the weight reduction of the cushion pad 1 can be realized as compared with the case where a high weight material is used by focusing only on the hardness of the hard foam 20.

As shown in FIG. 1 to FIG. 3, the hard foam 20 is arranged at positions corresponding to lower portions on a front side and both left and right sides of the cushion pad 1. As a result, the hard foam 20 supports the cushion pad 1 such that the thigh of the occupant seated on the seat, and the left and right sides of the buttocks of the occupant seated on the left and right ends of the seat are not excessively sunk into the cushion pad 1.

A wire 30 is embedded inside the urethane pad 10. Specifically, when the urethane pad 10 is molded by using a molding die for foam molding, the urethane pad 10 is foamed and molded in a state where the wire 30, in which wire material is molded into a predetermined shape, is preliminarily arranged inside the molding die. As a result, the wire 30 is embedded in the urethane pad 10. The wire 30 is used as a framework for ensuring rigidity of the urethane pad 10 as the seat cushion, and is formed along the outer shape of the cushion pad 1. That is, the wire 30 is a frame member of the urethane pad 10.

As shown in FIGS. 1 and 2, mounting protrusions 1a protruding obliquely upward are provided on both left and right sides of the rear end of the urethane pad 10. Mounting protrusions 1b protruding downward are provided on both left and right lower portions of a front end of the urethane pad 10. The mounting protrusions 1a are configured to embed the wire 30 inside the urethane pad 10. The mounting protrusions 1b are configured such that the wire 30 protrudes from the urethane pad 10. The wire 30 configuring the mounting protrusions 1b is bent into a U-shape so as to protrude downward. The mounting protrusions 1a and the mounting protrusions 1b are used as fixing means for fixing the cushion pad 1 to the vehicle body. When the cushion pad 1 is fixed to the vehicle body, the cushion pad 1 is covered with a seat cover (not shown).

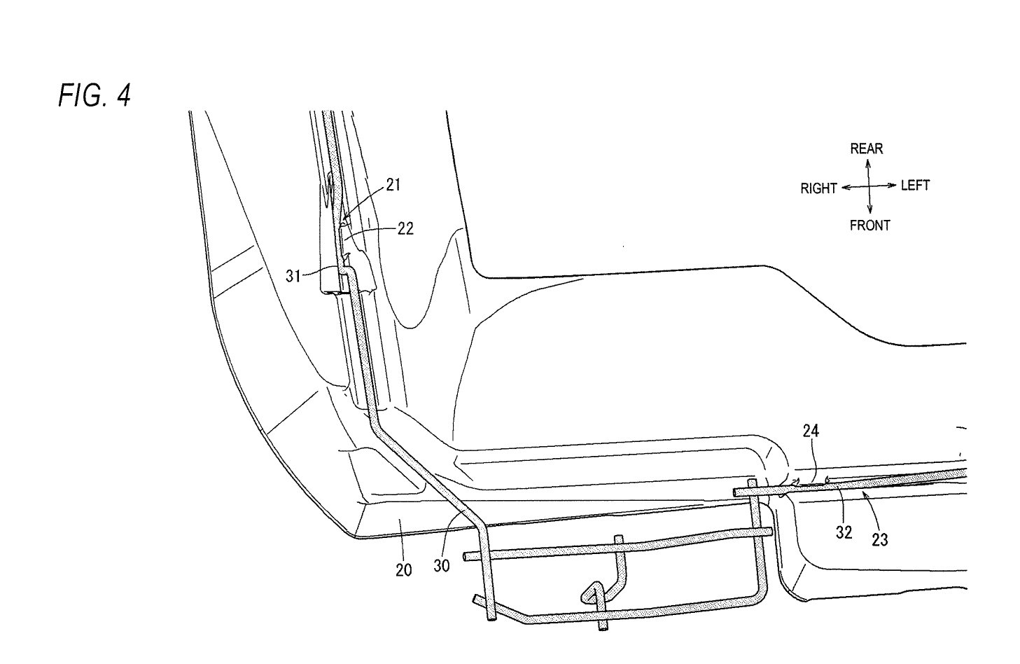

As shown in FIGS. 1 and 2, a portion of the urethane pad 10 corresponding to the hard foam 20 is provided with protruding shape portions 31, 32 (corresponding to engagement protrusions in the present invention) in which the wire 30 protrudes downward. As shown in FIGS. 1, 2, 4, 5, and 7, the protruding shape portions 31 have a shape in which the middle of the wire 30 extending in a front-rear direction bends downward and protrudes downward on both left and right side portions of the urethane pad 10. As shown in FIGS. 1, 2, 4, 6, and 10, the protruding shape portions 32 have a shape in which the middle of the wire 30 extending in a left-right direction bends downward and protrudes downward on both left and right side portions of the front side of the urethane pad 10. In FIG. 4 to FIG. 6, the illustration of the urethane pad 10 is omitted in order to make it easy to understand the arrangement of the wires 30 with respect to the hard foam 20.

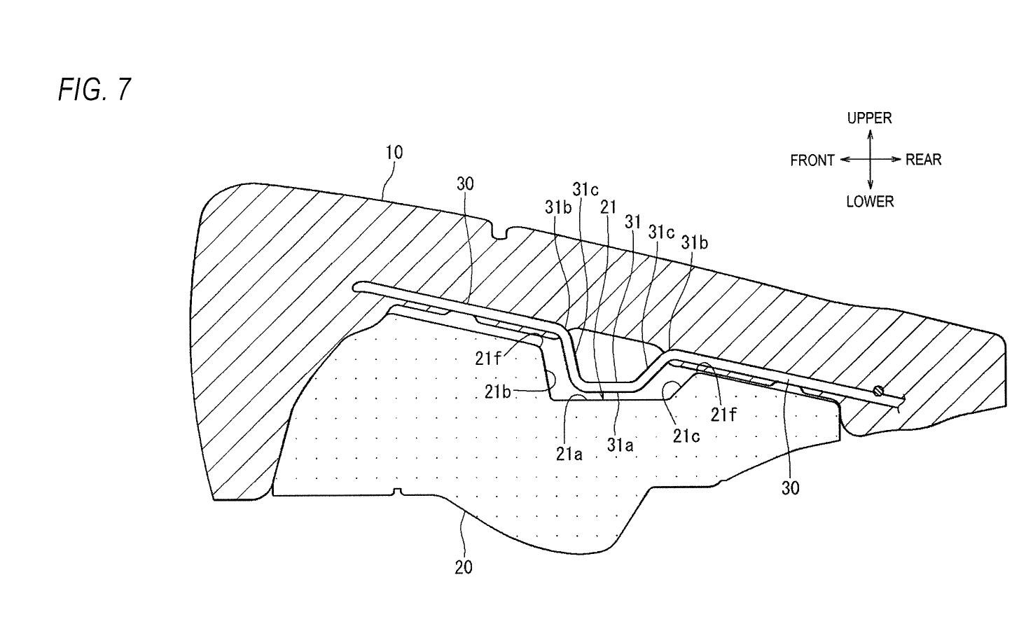

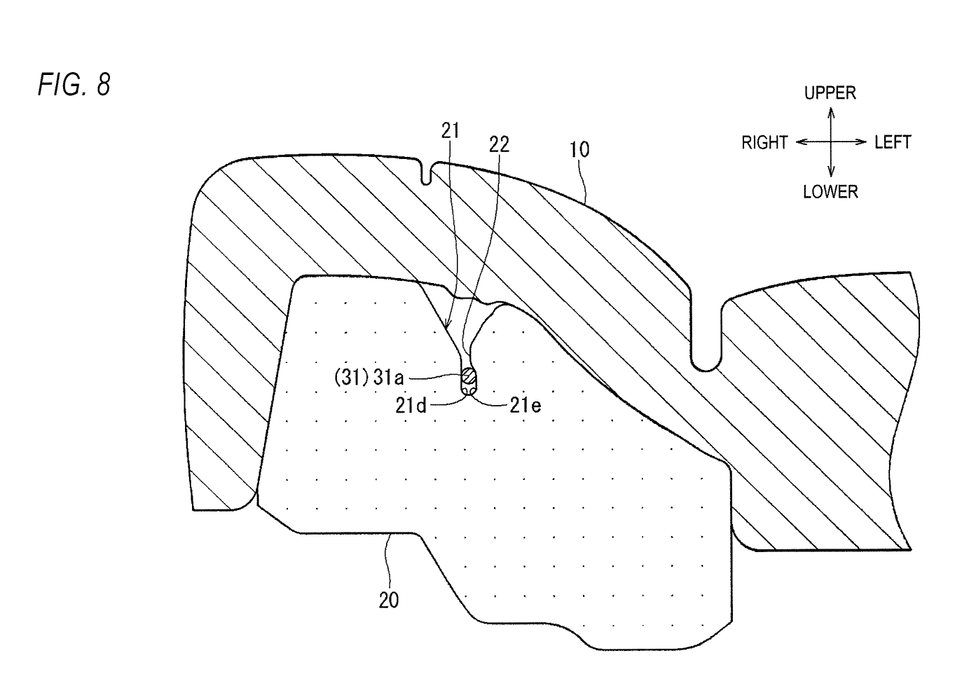

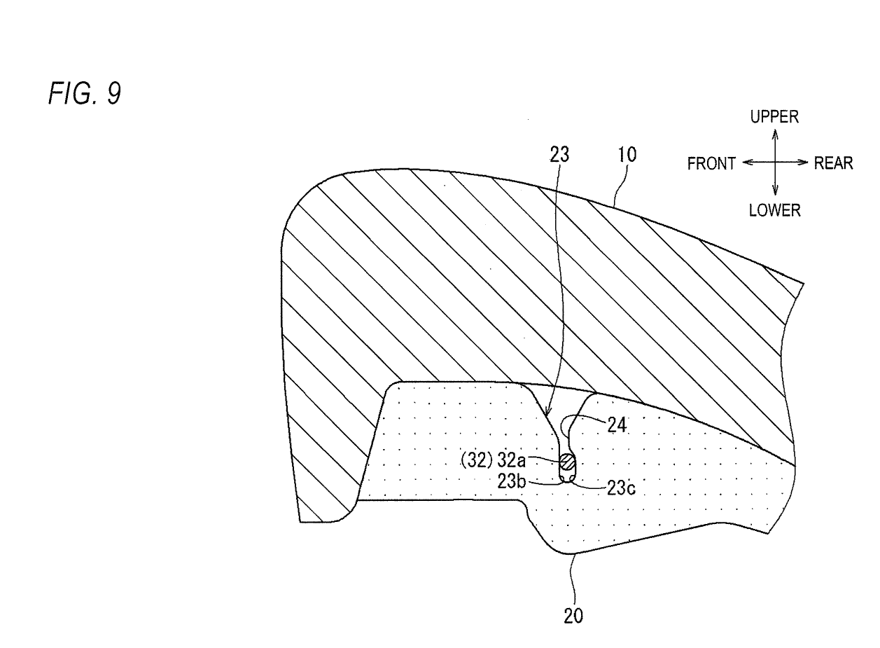

Recessed portions 21, 23 as shown in FIG. 4 to FIG. 10 are formed in the hard foam 20 so as to correspond to the protruding shape portions 31, 32. The recessed portions 21, 23 are recesses capable of receiving the protruding shape portions 31, 32 therein. The recessed portion 21 is configured to sandwich the protruding shape portion 31 from each of the front, rear, left, and right directions. The recessed portion 23 is configured to sandwich the protruding shape portion 32 from a front-rear direction. Specifically, as shown in FIG. 7 and FIG. 8, the recessed portion 21 includes the wall surfaces 21b, 21c, 21d, 21e corresponding to each of the front, rear, left and right directions of the protruding shape portion 31. As shown in FIG. 9, the recessed portion 23 includes the wall surfaces 23b, 23c corresponding to the front-rear direction of the protruding shape portion 32.

By inserting the protruding shape portions 31, 32 of the urethane pad 10 into the recessed portions 21, 23 of the hard foam 20, the urethane pad 10 is fixed to the hard foam 20 so as not to move relative to the hard foam 20 in each of the front, rear, left, and right directions.

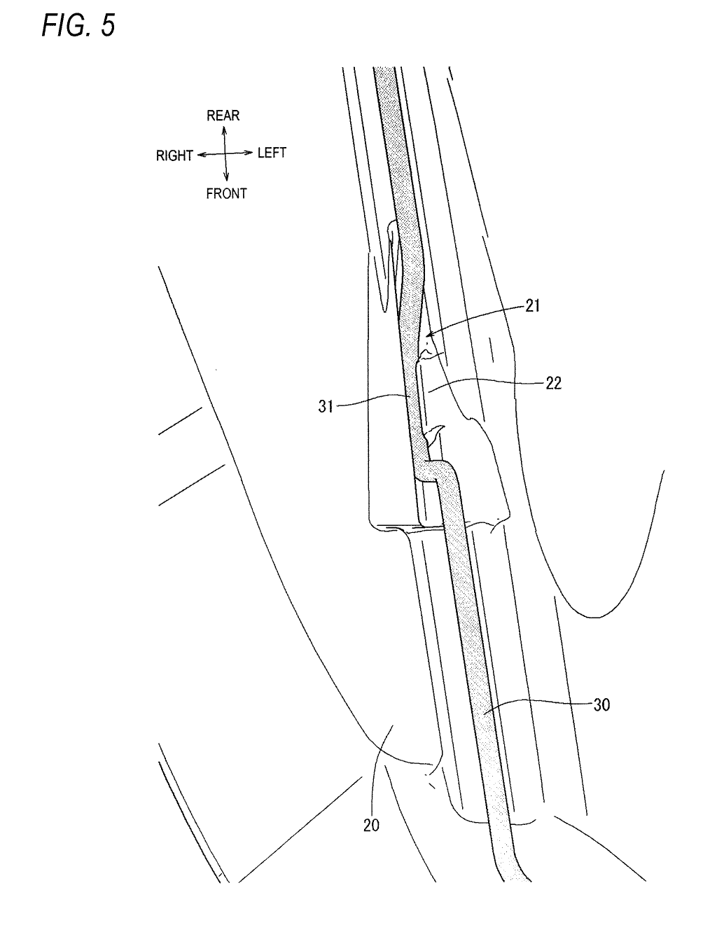

As shown in FIGS. 5 and 8, the left wall surface 21e of the recessed portion 21 of the hard foam 20 is formed with the protruding portion 22 protruding toward the opposing right wall surface 21d. The protruding portion 22 is formed so as to be positioned above the protruding end side portion 31a of the protruding shape portion 31 when the protruding shape portion 31 is inserted into the recessed portion 21. The protruding portion 22 suppresses the protruding shape portion 31 from moving upward. As a result, the urethane pad 10 (in which the wire 30 configuring the protruding shape portion 31 is embedded) is suppressed from moving in a direction away from the hard foam 20 (having the protruding portion 22). That is, the protruding shape portion 31 and the protruding portion 22 are engaged with each other so as to restrict the relative movement in the directions described above. The protruding shape portion 31 corresponds to the “engagement portion” in the present invention.

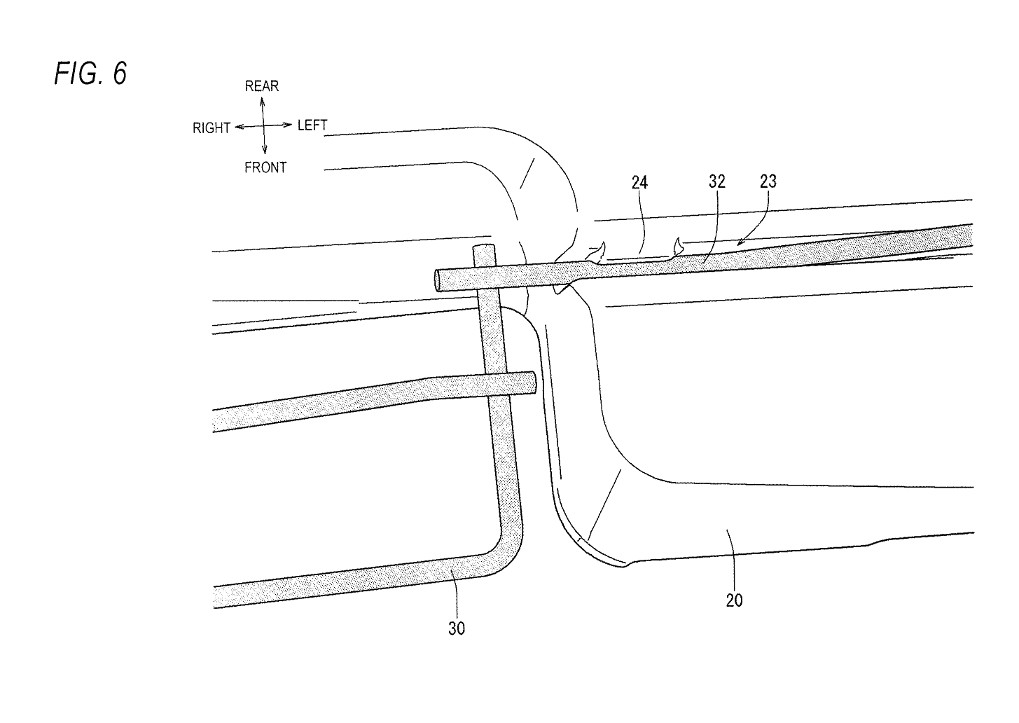

As shown in FIGS. 6, 9, and 10, the rear wall surface 23c of the recessed portion 23 of the hard foam 20 is formed with the protruding portion 24 protruding toward the opposing front wall surface 23b. The protruding portion 24 is formed so as to be positioned above the protruding end side portion 32a of the protruding shape portion 32 when the protruding shape portion 32 is inserted into the recessed portion 23. The protruding portion 24 suppresses the protruding shape portion 32 from moving upward. As a result, the urethane pad 10 (in which the wire 30 configuring the protruding shape portion 32 is embedded) is suppressed from moving in a direction away from the hard foam 20 (having the protruding portion 24). That is, the protruding shape portion 32 and the protruding portion 24 are engaged with each other so as to restrict the relative movement in the directions described above. The protruding shape portion 32 corresponds to the “engagement portion” in the present invention.

In forming the protruding portions 22, 24, an undercut portion is provided in the molding die of the hard foam 20. When the hard foam 20 is separated from the molding die after molding, the protruding portions 22, 24 are separated from the molding die while being pressed against the undercut portion of the molding die and deformed. In consideration of the separation from the molding die, the protruding portions 22, 24 are provided on the wall surfaces 21e, 23c located on a side closer to a center of gravity of the hard foam 20 among the wall surfaces 21d, 21e, 23b, 23c (see FIGS. 8 and 9).

Incidentally, if the protruding portions 22, 24 are provided on the wall surfaces 21d, 23b located on the side away from the center of gravity of the hard foam 20, when the hard foam 20 is separated from the molding die, not only the protruding portions 22, 24 but also the hard foam 20 located away from the center of gravity than the recessed portions 21, 23 (a portion from the recessed portions 21, 23 to an end portion of the hard foam 20. Generally, a wall thickness is thinner than the hard foam 20 on the side closer to the center of gravity) may be pressed against the molding die and deformed. In the present embodiment, since the protruding portions 22, 24 are provided on the wall surfaces 21e, 23c located on the side closer to the center of gravity of the hard foam 20, only the protruding portions 22, 24 and the periphery thereof are deformed when the protruding portions 22, 24 are pressed against the molding die, and deformation of most of the hard foam 20 as described above can be suppressed.

As shown in FIG. 7, the protruding shape portion 31 has a convex shape in which a part of the wire 30 protrudes toward the hard pad 20. The protruding shape portion 31 is configured such that a width of the protruding end side portion 31a corresponding to a protruding end of the convex shape in a front-rear direction is smaller than an interval between the pair of base end side portions 31b (in other words, bending start portions of the wire 30) corresponding to a base end of the convex shape. The recessed portion 21 has a recessed portion shape corresponding to the convex shape of the protruding shape portion 31. In other words, the recessed portion 21 is formed such that the recessed portion shape thereof corresponds to a bent shape of the protruding shape portion 31. Specifically, the recessed portion 21 has a recessed portion shape in which a width of the portion 21a arranged with the protruding end side portion 31a is smaller than a width of the portion 21f arranged with the pair of base end side portions 31b. In other words, the recessed portion 21 is formed such that a width of the portion 21a which receives the protruding end side portion 31a of the protruding shape portion 31 in a front-rear direction is smaller than an interval between the portions 21f corresponding to the base end side portion 31b.

In order to form the recessed portion 21 into the shape described above, the molding die for molding the recessed portion 21 of the hard foam 20 has a shape expanding in the front-back direction gradually in the direction of separating the molding die. Therefore, as compared with the case of providing the undercut portion in the molding die as described above, the hard foam 20 can be easily separated from the molding die, and the hard foam 20 can be easily manufactured.

A pair of connecting portions 31c which connect both front and rear sides of the protruding end side portion 31a to the pair of base end side portions 31b have different shapes (asymmetric shapes in a front-rear direction). Specifically, the pair of connecting portions 31c has a shape in which each angle (bending angle) formed by each of the wires 30 extending from the base end side portion 31b and each of the connecting portions 31c is different in the front-rear direction. In other words, a bending angle between the wire configuring one of the pair of connecting portions 31c and the wire 30 extending from one of the pair of base end side portions 31b is different from a bending angle between the wire configuring another of the pair of connecting portions 31c and the wire 30 extending from another of the pair of base end side portions 31b. The pair of connecting portions 31c is configured such that a bending angle of a rear side is larger than a bending angle of a front side. The wire 30 is configured such that the rear connecting portion 31c having a larger bending angle is located on a side where a seating pressure increases when the occupant sits on the seat. In other words, one of the pair of connecting portions 31c (a larger bending angle) is arranged at a position which receives a larger seating pressure than the other one of the pair of connecting portions 31c (a smaller bending angle) when the occupant sits on the seat. As a result, it is difficult for a bent wire 30 for forming the protruding shape portion 31 to bring a feeling of foreign matter to the buttock of the seated occupant.

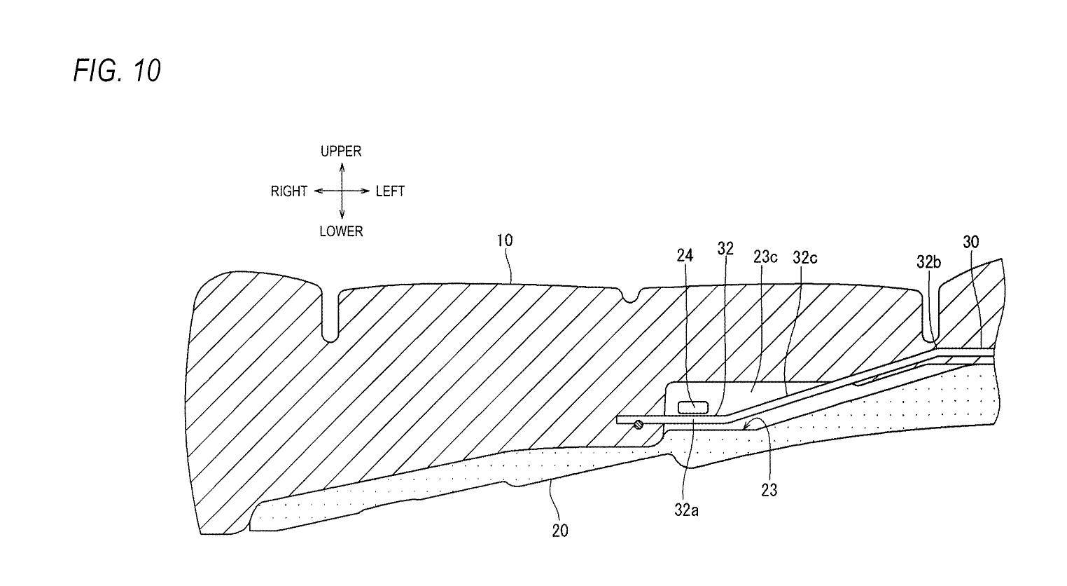

As shown in FIG. 10, the length of the connecting portion 32c connecting the protruding end side portion 32a and the base end side portion 32b is longer than that of the connecting portion 31c of the protruding shape portion 31. The bending angle formed by the wire 30 extending from the base end side portion 32b and the connecting portion 32c is larger than the bending angle of the connecting portion 31 of the protruding shape portion 31. As a result, it is difficult for the protruding shape portion 32 to bring the feeling of foreign matter to the thigh of the occupant.

As shown in FIGS. 1, 7, and 10, the protruding end side portions 31a, 32a and the connecting portions 31c, 32c are arranged such that the virtual plane to which the protruding end side portion 31a and the connecting portion 31c of the protruding shape portion 31 belongs and the virtual plane to which the protruding end side portion 32a and the connecting portion 32c of the protruding shape portion 32 belongs intersect with each other. This prevents the protruding shape portions 31, 32 from separating from the connecting portions 31c, 32c at the same time when an external force is applied to the cushion pad 1 from the front, rear, left, and right directions, and engaging force between the urethane pad 10 and the hard foam 20 as a whole of the cushion pad 1 can be enhanced.

Although a specific embodiment have been described above, the present invention is not limited to the appearances and configurations, various modifications, additions and deletions are possible without changing the spirit of the present invention.

For example, in the above embodiment, the vehicle seat according to the present invention is applied to the automobile rear seat. However, the vehicle seat according to the present configuration may be applied to a front seat of an automobile. Further, in the above embodiment, the structure of the vehicle seat according to the present invention is applied to the cushion pad of the seat cushion. However, the structure of the vehicle seat according to the present invention may be applied to the back pad of the seat back. In addition, in the above embodiment, the vehicle seat according to the present invention is applied to an automobile seat. However, the vehicle seat according to the present invention may be applied to a seat mounted on an airplane, a ship, a train, etc.

This application is based on Japanese Patent Application (JP-A-2016-128643), filed on Jun. 29, 2016, the contents of which are incorporated herein as reference.

### INDUSTRIAL APPLICABILITY

According to a vehicle seat of the present invention, the vehicle seat, in which a soft pad and a hard pad configuring the cushion material of the vehicle seat are mechanically integrated with each other, can be assembled to the vehicle without requiring adjustment of mutual positions of the soft pad and the hard pad. The present invention having this effect is useful for vehicle seats.

### DESCRIPTION OF REFERENCE NUMERALS

1 Cushion pad (vehicle seat)
1a, 1b Mounting protrusions
10 Urethane pad (cushion material, soft pad)
20 Hard foam (cushion material, hard pad)
21, 23 Recessed portions
22, 24 Protruding portions
21b˜21e, 23b, 23c Wall surfaces
30 Wire (frame member)
31, 32 Protruding shape portions (engagement portions and engagement protrusions)
31a, 32a Protruding end side portions
31b, 32b Base end side portions
31c, 32c Connecting portions

1. A vehicle seat comprising a cushion material in which a soft pad and a hard pad having different hardness from each other are combined,
wherein the soft pad is provided with an engagement protrusion protruding toward the hard pad,
wherein the hard pad is provided with a recessed portion receiving the engagement protrusion,
wherein the recessed portion has a wall surface,
wherein one of the wall surface and the engagement protrusion includes a protruding portion,
wherein another of the wall surface and the engagement protrusion includes an engagement portion which is engaged with the protruding portion, and
wherein the protruding portion and the engagement portion are engaged with each other to restrict relative movement between the soft pad and the hard pad in an assembling direction of the soft pad and the hard pad.

2. The vehicle seat according to claim 1,
wherein the soft pad is fixed to a frame member serving as a framework for ensuring rigidity as the vehicle seat, and
wherein the engagement protrusion is provided to the frame member.

3. The vehicle seat according to claim 2,
wherein the frame member is configured by a wire in which a wire material is molded into a predetermined shape, and
wherein the engagement protrusion is configured by the wire.

4. The vehicle seat according to claim 3,
wherein the engagement protrusion includes a protruding shape portion having a convex shape in which a part of the wire protrudes toward the hard pad, and
wherein the protruding shape portion is received in the recessed portion, configures the engagement portion, and is engaged with the protruding portion provided on the wall surface.

5. The vehicle seat according to claim 4,
wherein the protruding shape portion is configured such that a width of a protruding end side portion corresponding to a protruding end of the convex shape is smaller than an interval between a pair of base end side portions corresponding to a base end of the convex shape, and
wherein the recessed portion has a recessed portion shape which corresponds to the convex shape, a width of a portion of the recessed shape portion where a pair of the protruding end side portions are arranged being smaller than a width of a portion of the recessed shape portion where the base end side portion is arranged.

6. The vehicle seat according to claim 5,
wherein the protruding shape portion includes a pair of connecting portions which connect the protruding end side portion and the pair of base end side portions,
wherein a bending angle between the wire configuring one of the pair of connecting portions and the wire extending from one of the pair of base end side portions is larger than a bending angle between the wire configuring another of the pair of connecting portions and the wire extending from another of the pair of base end side portions, and
wherein the one of the pair of connecting portions is arranged at a position where a larger seating pressure is received as compared with the other of the pair of connecting portions when an occupant sits on the vehicle seat.

7. The vehicle seat according to claim 1,
wherein the recessed portion includes a pair of the wall surfaces, and
wherein, among the pair of wall surfaces, the protruding portion is provided on the wall surface which is provided at a position closer to a center of gravity of the hard pad.

8. The vehicle seat according to claim 4,
wherein the wire includes a plurality of the protruding shape portions, and
wherein the plurality of protruding shape portions are arranged such that a virtual plane to which the wire configuring one of the plurality of protruding shape portions belongs and a virtual plane to which the wire configuring another of the plurality of protruding shape portions belongs intersect with each other.
